(19) United States
(12) Patent Application Publication
(10) Pub. No.: US 2026/0183652 A1
(43) Pub. Date: Jul. 2, 2026

(54) INPUT OPERATION APPARATUS

(71) Applicant: Konami Arcade Games Co., Ltd., Tokyo (JP)

(72) Inventors: Takahiro ENDO, Tokyo (JP); Yuichi Oyama, Tokyo (JP); Hirotsugu Fukuyoshi, Tokyo (JP); Yuki Fujita, Tokyo (JP); Kaito Tanaka, Tokyo (JP); Rina Sakanoue, Tokyo (JP); Yuichi Masuda, Tokyo (JP); Hidenori Kotera, Tokyo (JP)

(73) Assignee: Konami Arcade Games Co., Ltd., Tokyo (JP)

(21) Appl. No.: 19/546,520

(22) Filed: Feb. 23, 2026

Related U.S. Application Data
(63) Continuation of application No. PCT/JP2024/029629, filed on Aug. 21, 2024.

(30) Foreign Application Priority Data
Aug. 24, 2023 (JP) 2023-136272

(51) Int. Cl. A63F 13/245; A63F 13/44; A63F 13/814

(52) U.S. Cl. CPC A63F 13/245; A63F 13/44; A63F 13/814

(57) ABSTRACT

An input operation apparatus includes a plurality of input elements that receive a same type of user operation in a game. The plurality of input elements includes: a first input element; and a second input element positioned closer to a user than the first input element. The first input element has a greater size than the second input element.

### CROSS REFERENCE TO RELATED APPLICATIONS

This Application is a Continuation Application of PCT Application No. PCT/JP2024/029629 filed on Aug. 21, 2024, and is based on and claims priority from Japanese Patent Application No. 2023-136272 filed on Aug. 24, 2023, the entire contents of each of which are incorporated herein by reference.

### BACKGROUND

### Technical Field

This disclosure relates to techniques for accepting user input operations.

Conventional arcade games operate in response to user operation on input elements. For example, Non-Patent Literature 1 (CHUNITHUM, <URL: https://chunithm.sega.jp/>, searched Aug. 13, 2023.) discloses a music game that operates in response to sequential user operation in synchronization with the playback of a music piece. The user operates buttons arranged in a horizontal direction. Across the buttons, their shapes and sizes are identical.

### SUMMARY

Since the buttons disclosed in Non-Patent Document 1 are used for the same type of user operation in a music game, it is desirable for the user to be able to operate the buttons in the same manner. However, in practice, input elements positioned farther from the user may be more difficult to operate, compared with those positioned closer to the user. In view of the above circumstances, one aspect of this disclosure is to facilitate user operation of the input elements positioned farther from the user among a plurality of input elements that receive the same type of user operation in a game.

In order to solve the problem, an input operation apparatus according to an aspect of this disclosure includes a plurality of input elements that receive a same type of user operation in a game. The plurality of input elements includes: a first input element; and a second input element positioned closer to a user than the first input element. The first input element has a greater size than the second input element.

### BRIEF DESCRIPTION OF THE DRAWINGS

FIG. 1 is a perspective view of a game system according to an embodiment of this disclosure.

FIG. 2 is a schematic view of the game system.

FIG. 3 is a block diagram showing a functional configuration of the game system.

FIG. 4 is a schematic diagram of a music game screen.

FIG. 5 is a schematic view of buttons.

FIG. 6 is a schematic view of a set of controls according to a modification.

FIG. 7 is a schematic view of a set of controls according to a modification.

FIG. 8 is a schematic view of a set of controls according to a modification.

FIG. 9 is a schematic view of a set of controls according to a modification.

FIG. 10 is a schematic view of a set of controls according to a modification.

FIG. 11 is a schematic view of a set of controls according to a modification.

FIG. 12 is a schematic view of a set of controls according to a modification.

FIG. 13 is a schematic view of a set of controls according to a modification.

FIG. 14 is a schematic view of a set of controls according to a modification.

FIG. 15 is a schematic view of a set of controls according to a modification.

### DESCRIPTION OF THE EMBODIMENT

An embodiment of this disclosure will be described with reference to the drawings. The embodiments described below include a variety of limitations that are not essential to this disclosure. The scope of this disclosure is not limited to the following embodiments.

### Embodiment

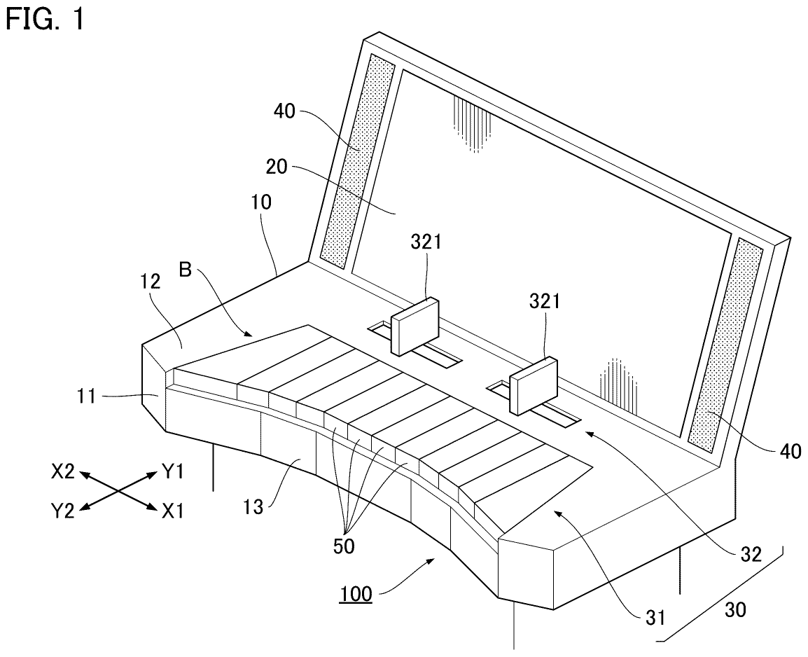

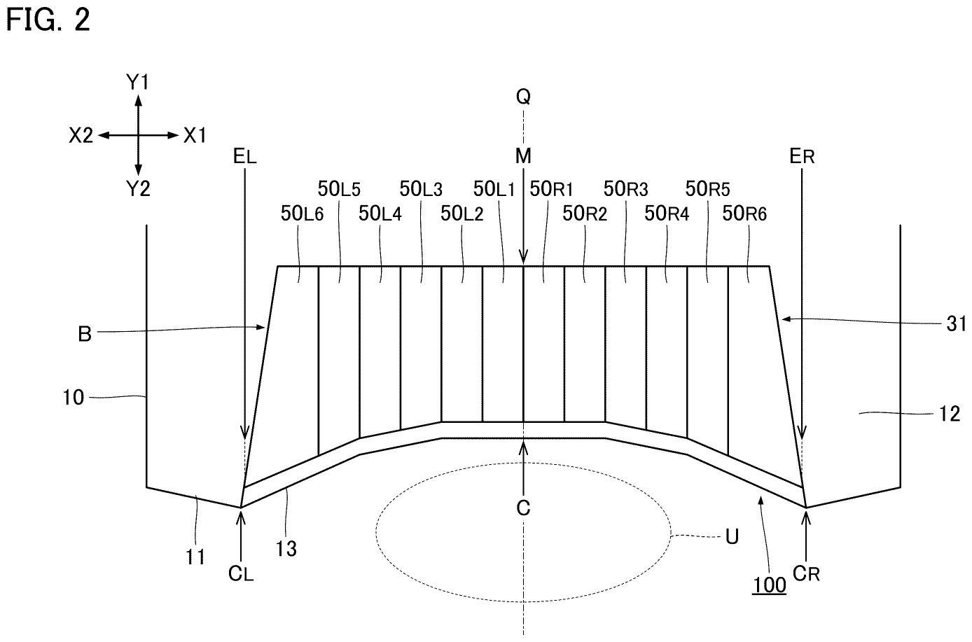

FIG. 1 is a perspective view of a game system 100 according to an embodiment of this disclosure. FIG. 2 is a partial top view of the game system 100 taken along a vertical axis. In this embodiment, the game system 100 is a computer system that provides a music game to a user (player) U. The music game is a rhythm-based timing game that prompts the user U to perform operations at timings synchronized with the playback of a music piece.

In one example, the game system 100 is installed in a gaming facility. Examples of the gaming facility include an entertainment facility, such as a game center or a casino, and a commercial facility, such as a shopping center. The game system 100 is an example of an “input operation apparatus.”

As shown in FIG. 2, in this embodiment, a reference plane Q is defined as a vertical plane corresponding to a plane of symmetry of the game system 100. The outer shape of the game system 100 is substantially symmetric with respect to the reference plane Q. The user U plays the music game at a position aligned with the reference plane Q (i.e., in front of the game system 100). It is noted that the outer shape of the game system 100 may alternatively be asymmetric. In the following description, viewing any element of the game system 100 taken along the vertical axis is referred to as “plan view.”

As shown in FIGS. 1 and 2, the game system 100 includes a housing 10 that constitutes the exterior structure of the game system 100. The housing 10 includes a display 20, a plurality of controls 30, and a sound emitting device 40. The display 20 displays a variety of images related to the music game and may be a display panel, such as a liquid crystal panel or an organic electroluminescent panel. The controls 30 serves as input devices operated by the user U. The sound emitting device 40 comprises two or more speaker devices and outputs playback sound of the music game.

The housing 10 includes a front surface 11 and a console panel 12. The front surface 11 is an exterior surface that faces the user U. Specifically, the front surface 11 faces the waist or abdomen of the user U. The console panel 12 is substantially horizontal. The console panel 12 is disposed at a position for placement of both the hands of the user U. The controls 30 are disposed on the console panel 12. The console panel 12 may be inclined at a predetermined angle relative to the horizontal plane.

The display 20 is disposed in front of the user U, facing the front surface 11. When viewed along the vertical axis, the console panel 12 is positioned between the front surface 11 of the housing 10 and the display 20. The screen of the display 20 is inclined upward at a predetermined angle relative to the console panel 12 and may alternatively be perpendicular to the console panel 12. In one example, the sound emitting device 40 is disposed on a side or above the display 20.

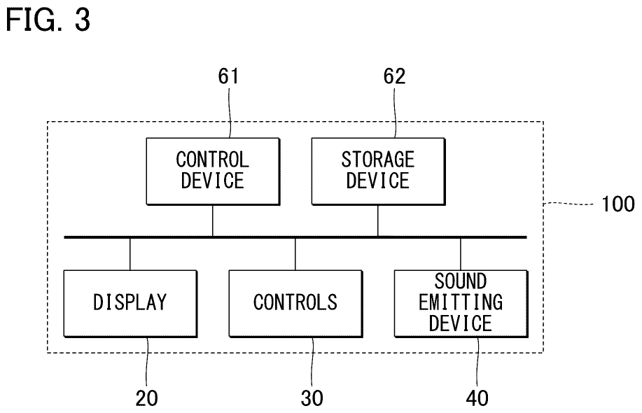

FIG. 3 is a block diagram showing a configuration of the game system 100. As shown in FIG. 3, the game system 100 includes a control device 61 and a storage device 62 in addition to the display 20, the controls 30, and the sound emitting device 40. The game system 100 may be implemented not only as a single device, but also as separate devices.

The control device 61 comprises one or more processors that control elements of the game system 100. For example, the control device 61 may comprise one or more types of processors, such as CPUs (Central Processing Units), GPUs (Graphics Processing Units), SPUs (Sound Processing Units), DSPs (Digital Signal Processors), FPGAs (Field Programmable Gate Array), or ASICs (Application Specific Integrated Circuits).

The storage device 62 compresses one or more memories that store programs executed by the control device 61 and a variety of types of data used by the control device 61. The storage device 62 may be a known recording medium, such as a magnetic recording medium, or a semiconductor recording medium. The storage device 62 may include a combination of one or more types of recording media. Alternatively, the storage device 62 may be a portable recording medium that is attached to, and detached from, the game system 100.

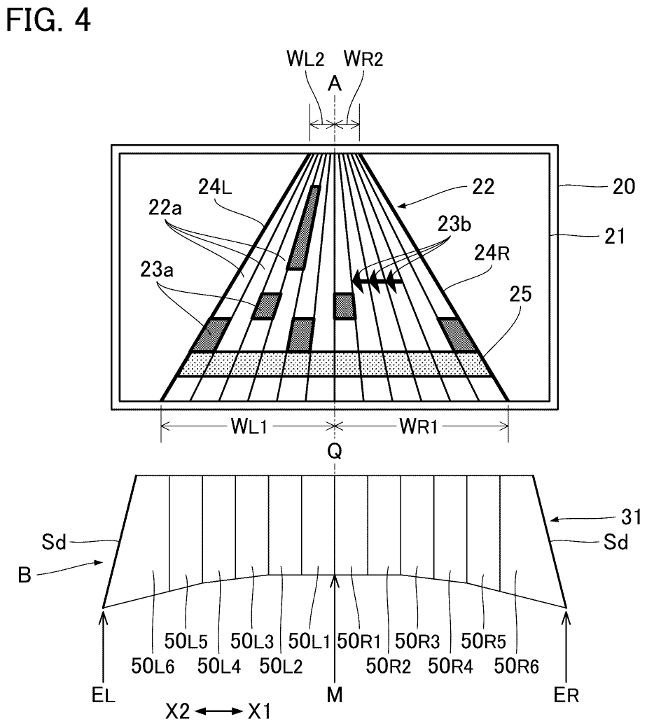

The control device 61 executes a program stored in the storage device 62 and controls the music game. In one example, the control device 61 plays back a music piece of the music game using the sound emitting device 40, displays a screen shown in FIG. 4 (hereinafter, “music game screen 21”) on the display 20, and operates the music game in response to operation of the user U performed on the controls 30.

The music game screen 21 indicates an image displayed on the display 20 in conjunction with the operation of the music game. As shown in FIG. 4, in this embodiment, the music game screen 21 includes a lane area 22 and a plurality of notes 23 (23a and 23b).

The lane area 22 is defined as a strip-shaped object disposed in a virtual space. Specifically, the lane area 22 is elongated and has a boundary edge 24R and a boundary edge 24L. The boundary edges 24R and 24L are straight, which constitutes the outline of the lane area 22. As shown in FIG. 4, a central axis A of the lane area 22 is equidistant from the boundary edges 24R and 24L, and lies in the reference plane Q. However, the central axis A may be inclined relative to the reference plane Q, or a position or angle of the central axis A relative to the reference plane Q changes in conjunction with the operation of the music game. In this embodiment, the lane area 22 includes two or more lanes 22a that are arranged along the X-axis, that is, arranged in the horizontal line.

Objects disposed in the music game screen 21 are three-dimensional images and are rendered by a perspective method. The boundary edges 24R and 24L are inclined relative to the central axis A set in the lane area 22. Specifically, the boundary edge 24R is inclined relative the central axis A such that a distance WR1 from the central axis A to the lower end of the boundary edge 24R is greater than a distance WR2 from the central axis A to the upper end of the boundary edge 24R. Similarly, the boundary edge 24L is inclined relative to the central axis A such that a distance WL1 from the central axis A to the lower end of the boundary edge 24L is greater than a distance WL2 from the central axis A to the upper end of the boundary edge 24L. Thus, the lane area 22 of the music game screen 21 is trapezoidal. Alternatively, the lane area 22 may be triangular with the boundary edges 24R and 24L meeting at a single point. As described above, an image disposed such that the boundary edges 24R and 24L are inclined relative to the central axis A shows the depth of the lane area 22 in the virtual space.

The notes 23 are objects each indicating a timing of user operation by the user U. The notes 23 may further be expressed as indicators that instruct the user U regarding the timings of the user operations. The notes 23 are arranged in the lane area 22. The lane area 22 and the notes 23 move along extension of the lane area 22 (i.e., the depth of the virtual space) in conjunction with playback of the music piece via the sound emitting device 40. If the lane area 22 is rendered as a two-dimensional image, the lane area 22 and the notes 23 move vertically.

The notes 23 includes timing notes 23a and arrow notes 23b. The timing notes 23a are ones of the notes 23 and each indicate a timing of a user operation performed by the user U. Specifically, the timing notes 23a are disposed on one or more selected lanes 22a. The arrow notes 23b are ones of the notes 23 and each indicate the user U both the timing and the direction (right or left) of the operation.

A target position 25 is set at a predetermined point toward the end of the lane area 22. In the music game, the user U is required to operate when the notes 23 each reach the target position 25. The control device 61 evaluates the play of the user U based on the differences between the timings at which the notes 23 each reach the target position 25 and the timings at which the user U operates the controls 30, and assigns a score to the user U based on the evaluation result.

Next, the controls 30 will be described. Hereinafter, as shown in FIGS. 1 and 2, an X-axis and a Y-axis, which are orthogonal to each other, are defined in a horizontal plane parallel to the console panel 12. The X-axis is an example of the “first axis,” and the Y-axis is an example of the “second axis.”

The X-axis includes an X1 direction, and an X2 direction that is opposite to the X1 direction. The X1 direction corresponds to the right as viewed from the user U, and the X2 direction corresponds to the left as viewed from the user U. The Y axis includes a Y1 direction and a Y2 direction that is opposite to the Y1 direction. The Y1 direction corresponds to the rear side as viewed from the user U, and the Y2 direction corresponds to the front side as viewed from the user U. The Y1 direction is an example of the “first direction,” and the Y2 direction is an example of the “second direction.”

In this embodiment, as shown in FIG. 1, the controls 30 include a first set of controls 31 and a second set of controls 32. The first set of controls 31 includes twelve buttons 50 arranged along the X axis. The buttons 50 are button-type controls (keys) to be pressed by the user U. Specifically, the buttons 50 are biased upward by elastic members, such as springs (not shown), and are displaced downward from their initial positions when pressed by the user U. When the pressing is released by the user U, the buttons 50 are displaced upward by the biasing of the elastic elements and return to the initial position. The first set of controls 31 can have any number of buttons 50.

When a timing note 23a reaches the target position 25, the user U operates one or more of the twelve buttons 50 that correspond to the position (lane 22a) on the X-axis of the timing note 23a. As described above, in this embodiment, the twelve buttons 50 receives input operations for the respective timing notes 23a during the musical game. In other words, the twelve buttons 50 receive the same type of user operation in the music game. The buttons 50 are referred to as elements operated by the user U and are each an example of an “input element.”

The second set of controls 32 includes two faders 321. The faders 321 are ones of the controls and are slidable along the X axis by the user U. In plan view, the second set of controls 32 is positioned between the first set of controls 31 and the display 20. When an arrow note 23b reaches the target position 25, the user U operates each fader 321 in a direction indicated by the arrow note 23b. Thus, in this embodiment, the twelve buttons 50 and the two faders 321 are disposed on the console panel 12 of the housing 10.

FIG. 2 depicts the midpoint M, the right end ER, and the left end EL in a line B of the twelve buttons 50 (50R1 to 50R6, and 50L1 to 50L6). The right end ER indicates an end of the line B in the X1 direction. The left end EL indicates an end of the line B in the X2 direction. The midpoint M indicates a point equidistant from the right end ER and the left end EL on the X axis. Here, the midpoint M is an example of a position of the user U in front of the line B of the twelve buttons 50. One of the right end ER and the left end EL is an example of a “first end,” and the other is an example of a “second end.”

In this embodiment, the midpoint M is positioned within the reference plane Q. The central axis A of the lane area 22 on the music game screen 21 coincides with the midpoint M of the line B of the twelve buttons 50 along the X axis. Specifically, as shown in FIG. 4, along the X axis, the lane area 22 on the music game screen 21 is positioned within a range defined by the twelve operation buttons 50, that is, between the right end ER and the left end EL.

As shown in FIG. 2, the twelve buttons 50 are divided into two groups: six buttons 50R1 to 50R6 arranged in the X1 direction from the midpoint M (reference plane Q), and six buttons 50L1 to 50L6 arranged in the X2 direction from the midpoint M. The six buttons 50R1 to 50R6 are buttons 50 that are typically operated by the user's right hand. The six buttons 50L1 to 50L6 are buttons 50 that are typically operated by the user's left hand. The buttons 50 may be operated by either the right hand or the left hand.

The buttons 50 are symmetric with respect to an axis orthogonal to the X-axis at the midpoint M of the line B. The axis of symmetry is parallel to the Y-axis and passes through the midpoint M. Accordingly, among the twelve buttons 50, each corresponding pair of buttons 50Rn and 50Ln (n=1 to 6) is symmetrical. As a result, the game system 100 can achieve a perceived unified design appearance, as compared to when the buttons 50 are asymmetric.

Since the buttons 50 are symmetric, the following description will primarily refer to the six buttons 50R1 to 50R6 arranged in the X1 direction from the midpoint M, which also represents the six buttons 50L1 to 50L6 arranged in the X2 direction. When it is unnecessary to distinguish individual buttons 50, they are simply referred to as “buttons 50.”

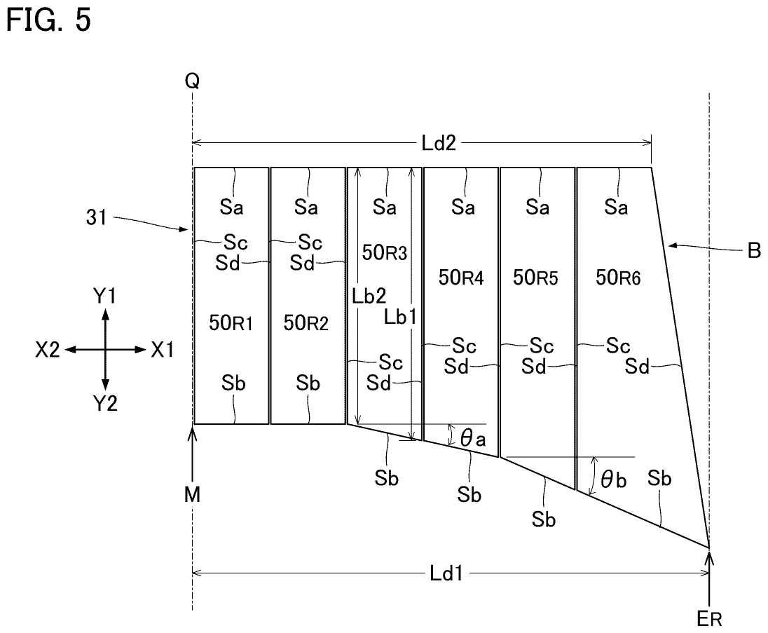

FIG. 5 is a schematic view of the six buttons 50R1 to 50R6. As shown in FIG. 5, from among the six buttons 50R1 to 50R6, the button 50R1 is positioned closest to the midpoint M, and the button 50R6 is positioned closest to the right end ER. The button 50R2 is adjacent to the button 50R1 in the X1 direction; the button 50R3 is adjacent to the button 50R2 in the X1 direction; the button 50R4 is adjacent to the button 50R3 in the X1 direction; the button 50R5 is adjacent to the button 50R 4 in the X1 direction; the button 50R 6 is adjacent to the button 50R5 in the X1 direction.

The user U plays the music game with the midpoint M positioned directly in front of the user. From among the six buttons 50R1 to 50R6, the button 50R1 is positioned closest to the user U, and the button 50R6 is positioned farthest from the user U. Specifically, the button 50R2 is positioned farther from the user U than the button 50R1; the button 50R3 is positioned farther from the user U than the button 50R2; the button 50R4 is positioned farther from the user U than the button 50R3; the button 50R5 is positioned farther from the user U than the button 50R4; and the button 50R6 is positioned farther from the user U than the button 50R5.

As shown in FIG. 5, the size of the button 50R1 is identical to that of the button 50R2. However, the sizes of the buttons 50R3 to 50R6 are larger than those of the buttons 50R1 and 50R2. Within the buttons 50R3 to 50R6, the closer a button 50Rn is to the right end ER of the line B, the larger the size. Specifically, the button 50R4 is larger than the button 50R3; the button 50R5 is larger than the button 50R4; and the button 50R6 is larger than the button 50R5. Thus, among the buttons 50R3 to 50R6, the farther a button 50 is from the user U, the larger the size.

Here, the buttons 50R1 and 50R6 will be described. Among the six buttons 50R1 to 50R6, the button 50R6 is positioned closer to the right end ER of the line B than to the midpoint M of the line B. Conversely, the button 50R1 is positioned closer to the midpoint M than to the right end ER. Thus, the button 50R1 is positioned closer to the user U than the button 50R6. In this configuration, the size of the button 50R6 is greater than that of the button 50R1. The button 50R6 is an example of a “first input element,” and the button 50R1 is an example of a “second input element.”

As shown in FIG. 2, the button 50L6 is one of the twelve buttons 50 and is positioned closer to the left end EL than to the midpoint M of the line B. The button 50L6 is symmetrical with respect to the button 50R6. Accordingly, the size of the button 50L6 is greater than that of each of the buttons 50R1 and 50L1. The button 50L6 is an example of a “third input element.”

As described above, in this embodiment, the size of the button 50R6 (positioned closer to the right end ER among the twelve buttons 50) is greater than that of button 50R1 (positioned closer to the midpoint M and closer to the user U). As a result, compared to when all buttons 50 are identical in size, the button 50R6 positioned farther from the user U can be operated more easily. In particular, in addition to the button 50R6 closer to the right end ER, the size of the button 50L6 closer to the opposing left end EL is greater than that of the button 50R1 closer to the midpoint M of the line B. As compared to when all buttons 50 are identical in size, the user operation of the buttons 50R6 and 50L6 positioned closer to both ends of the line B is easier.

In plan view as shown in FIG. 5, the outline of each button 50Rn is defined by four edges, Sa, Sb, Sc, and Sd. Thus, each button 50Rn has a substantially rectangular shape surrounded by the edges Sa, Sb, Sc, and Sd. The corners of the button 50Rn are formed in an arc shape.

The edge Sa, which corresponds to an upper end (the Y1 direction) of the outline of the button 50Rn, serves as an example of the ‘first edge.” The edge Sb, which corresponds to a lower end (Y2 direction) of the outline of the button 50Rn, serves as an example of the “second edge.”

The edges Sc and Sd are disposed between the upper edge Sa and the lower edge Sb of the outline of the button 50Rn. The edge Sd is positioned between the edge Sc and the right end ER of the line B. Accordingly, the edge Sc defines the left side of the button 50Rn, and the edge Sd defines the right side thereof. A length of the edge Sd of the button 50Rn is equal to that of the edge Sc of the adjacent button 50Rn+1 (the X1 direction). The edge Sc is an example of the “third edge,” and the edge Sd is an example of the “fourth edge.”

As shown in FIG. 5, for each button 50, the lengths of the edges Sc and Sd are greater than the lengths of the edges Sa and Sb. Accordingly, each button 50 has a rectangular shape elongated along the Y-axis direction.

The buttons 50 each have an edge Sa that is a straight line extending along the X-axis. Across the twelve buttons 50, the lengths of the edges Sa are identical, and the positions of the edges Sa along the Y-axis are also identical. Accordingly, the edges Sa of the twelve buttons 50 are arranged linearly along the X-axis. According to this configuration, as compared to when the position of the edge Sa along the Y-axis differs for each button 50, a unified design appearance can be easily achieved, and the installation structure for the buttons 50 can be simplified. Furthermore, the buttons 50 each have an identical position of the edge Sa. As a result, the user U can more easily recognize the correspondence between each lane 22a of the music game screen 21 and the respective buttons 50, as compared to when the buttons 50 each have a different position of the edge Sa. Conversely, the buttons 50 each have a different orientation of the edge Sb.

The buttons 50R1 and 50R2 have the same shape. The edge Sb of both buttons is a straight line that extends along the X-axis. Accordingly, the planar shapes of the buttons 50R1 and 50R2 are elongated rectangular shapes that extend in the Y-axis direction.

The edge Sb of the button 50R3 is a straight line that is inclined relative to the X-axis. Specifically, as shown in FIG. 5, the edge Sb of the button 50R3 is inclined relative to the X-axis such that a distance Lb1 is greater than a distance Lb2 (Lb1>Lb2). Here, the distance Lb1 is defined as a distance from the edge Sa to the right end of the edge Sb (the end of the edge Sb close to the right end ER), and represents the length of the edge Sd. The distance Lb2 is defined as a distance from the edge Sa to the left end of the edge Sb (the end of the edge Sb close to the midpoint M), and represents the length of the edge Sc. Furthermore, although FIG. 5 exemplifies the button 50R3, the edge Sb of each of the buttons 50R4 to 50R6 is likewise a straight line that is inclined relative to the X-axis.

As will be clear from the description, for each of the buttons 50R3 to 50R6, the length of the edge Sb is greater than that of edge Sa. As a result, it is easy for the user U to operate portions of the buttons 50R3 to 50R6 in the vicinity of the edge Sb. In particular, the edge Sb of each of the buttons 50R3 to 50R6 is inclined relative to the X-axis such that the end of the edge Sb close to the right end ER extends in the Y2 direction than the other end of the edge Sb. This incline allows the user U to easily operate the portion in vicinity of the edge Sb of each button 50Rn, particularly the portion close to the right end ER.

As shown in FIG. 5, the edge Sb of each of the buttons 50R3 and 50R4 is inclined at an angle θa relative to the X-axis. The angle θa is an interior angle between the X-axis and the edge Sb of each of the buttons 50R3 and 50R4. Furthermore, the edge Sb of each of the buttons 50R5 and 50R6 is inclined at an angle θb relative to the X-axis. The angle θb is an interior angle between the X-axis and the edge Sb of each of the buttons 50R5 and 50R6. As shown in FIG. 5, the angle θb is greater than the angle θa (θb>θa). Here, the buttons 50R3 and 50R4 are examples of the “fourth input elements,” and the buttons 50R5 and 50R6 are examples of the “first input elements.” The buttons 50R3 and 50R4 are positioned between the buttons (50R1 and 50R2) and the buttons (50R5 and 50R6).

As described above, in this embodiment, the angle θb of the edge Sb of each of the buttons 50R5 and 50R6 is greater than the angle θa of the edge Sb of each of the buttons 50R3 and 50R4. This difference in angles produces a consistent design appearance in which the angle of the edge Sb varies progressively from the buttons 50R3 to 50R6. Furthermore, according to the configuration in which the angle θb is greater than the angle θa, a shape is provided in which the buttons 50 surround the front and sides of the user U. As compared with a configuration in which the angle θb is less than the angle θa, the buttons positioned closer to the right end ER and the left end EL of the line B are disposed closer to the user U. As a result, the input operation of the buttons 50 by the user U can be further facilitated.

As shown in FIG. 5, the edges Sc and Sd of the buttons 50R1 to 50R5 are straight lines aligned with the Y-axis. In other words, the edges Sc and Sd are parallel. For the button 50R6, the edge Sc is also a straight line aligned with the Y-axis, whereas the edge Sd is a straight line inclined relative to the Y-axis.

Specifically, the edge Sd of the button 50R6 is inclined relative to the Y-axis such that a distance Ld1 is greater than a distance Ld2 (Ld1>Ld2). Here, the distance Ld1 is defined as a distance along the X-axis from the midpoint M to the lower end of the edge Sd (the end closer to the edge Sb). The distance Ld2 is defined as a distance along the X-axis from the midpoint M and the upper end of the edge Sd (the end close to the edge Sa). The lower end of the edge Sd of the button 50R6 (the end of the edge Sd close to the edge Sb) corresponds to the right end ER of the line B.

As described above, in this embodiment, the edge Sd of the button 50R6 is inclined relative to the Y-axis. This inclination allows the user U to operate the button 50R6 with ease compared to when the edge Sd is parallel to the Y-axis. Additionally, the edges Sd of the buttons 50R6 and 50L6, as well as the boundary edges 24R and 24L of the lane area 22 on the music game screen 21, are inclined relative to the central axis A. As a result. as shown in FIG. 4, the user U can be given an impression that the boundary edge 24R of the lane area 22 and the edge Sd of the button 50R6 are seamlessly connected, and likewise that the boundary edge 24L and the edge Sd of the button 50L6 are seamlessly connected. Accordingly, a unified design appearance can be achieved across the display 20 and the controls 30. Furthermore, as a result of the perceived continuity between the lane area 22 and the buttons 50, the user U can more easily recognize a correspondence between the lanes 22a on the music game screen 21 and the buttons 50.

In this embodiment, as shown in FIGS. 1 and 2, the front surface 11 of the housing 10 has a recess 13. The recess 13 defines a space recessed in the Y1 direction from the viewpoint of the user U. Specifically, the inner peripheral surface of the recess 13 is formed of a plurality of planar surfaces that are mutually connected in an arcuate manner. As shown in FIG. 2, the midpoint C of the recess 13 along the X-axis lies within the reference plane Q. The midpoint C is equidistant from the right end CR in X1 direction and the left end CL in X2 direction.

As shown in FIG. 2, the user U can bring user's body close to the game system 100 by approaching the recess 13 in the housing 10. According to this configuration, the user U can operate the buttons 50 from a position closer to the first set of controls 31, as compared to when the front surface 11 of the housing 10 is flat and parallel to the X-axis (i.e., no recess 13 is on the front surface 11). Thus, the user U can more easily operate the button 50.

As shown in FIG. 2, the region of the front surface 11 having the recess 13 overlaps, along the X-axis, with the region of the first set of controls 31 (the twelve buttons 50). Specifically, the right end CR of the recess 13 along the X-axis coincides with the right end ER of the first set of controls 31, and the left end CL of the recess 13 along the X-axis coincides with the left end EL of the first set of controls 31. However, the recess 13 may have its right end CR and its left end CL arranged either inside or outside the right end ER and left end EL of the first set of controls 31.

As shown in FIG. 2, in plan view, the twelve buttons 50 each have a front-side edge Sb that extends along the recess 13. In other words, the edges Sb of the buttons 50 follow the inner periphery of the recess 13 in a polygonal, substantially arcuate shape in plan view. In this configuration, as compared to when the front edges Sb of the buttons 50 are parallel to the X-axis (e.g., see FIG. 11 described later), a unified design appearance between the front surface 11 (including the recess 13) of the housing 10 and the buttons 50 can be achieved. Moreover, when the edges Sb of the buttons 50 extend along the recess 13, rather than being arranged linearly along the X-axis, the buttons 50 close to the right end ER or left end EL are located closer to the user U. As a result, the user U can operate the buttons 50 more easily, and this effect is particularly pronounced.

### Modifications

Specific modifications of the foregoing embodiment are described below. Two or more modifications may be combined with each other in so far as such combination does not give rise to any conflict.

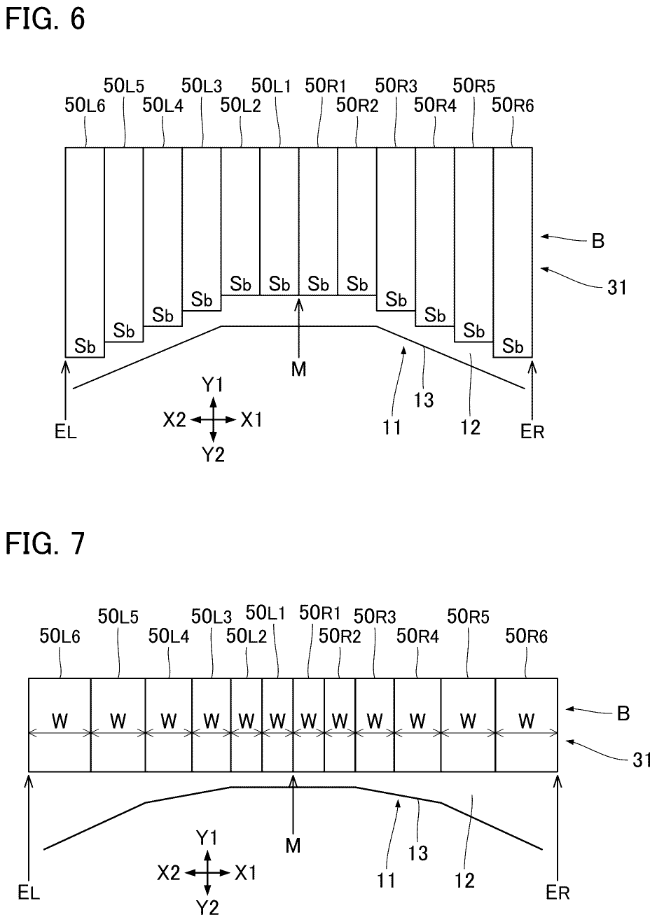

(1) In the foregoing embodiment, the edges Sb of the buttons 50R3 to 50R6 are inclined relative to the X-axis. However, as shown in FIG. 6, the edges Sb may instead be parallel to the X-axis. Specifically, as shown in FIG. 6, the edges Sb of the buttons 50R3 to 50R6 are positioned in the Y2 direction than the edges Sb of the buttons 50R1 and 50R2, and thus, the buttons 50R3 to 50R6 each have a greater size than the buttons 50R1 and 50R2. For the buttons 50R3 to 50R6 (n=3 to 6), the edge Sb of the button 50Rn is positioned in the Y2 direction than the edge Sb of the button 50Rn-1. As a result, the button 50Rn has a greater size than the button 50Rn-1.

(2) In the foregoing embodiment, the sizes of the buttons 50 differ in the Y-axis direction. However, the variation in the sizes of the buttons 50 is not limited to this example. For example, as shown in FIG. 7, the sizes of the buttons 50 may also differ based on their lateral widths in the X-axis direction.

As shown in FIG. 7, the buttons 50R3 to 50R6 each have a greater lateral width W than the buttons 50R1 and 50R2, and thus the buttons 50R3 to 50R6 each have a size greater than that of the buttons 50R1 and 50R2. The buttons 50 each have an identical length along the Y-axis. For the buttons 50R3 to 50R6 (n=3 to 6), the button 50Rn has a greater lateral width W than the button 50Rn-1, and thus, has a greater size than the button 50Rn-1.

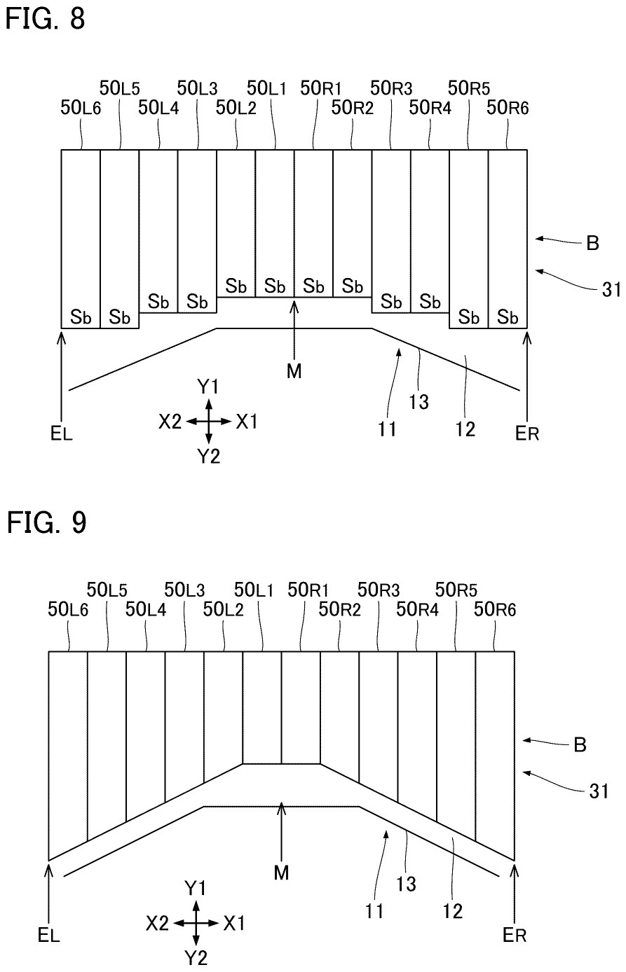

(3) In the foregoing embodiment, the shapes of the buttons 50R3 to 50R6 differ. However, the buttons 50R3 to 50R6 may also include two or more buttons 50 of the same shape. For example, as shown in FIG. 8, the buttons 50R3 and 50R4 may have the same shape, and the buttons 50R5 and 50R6 may also share the same shape.

(4) In the foregoing embodiment, the buttons 50R1 and 50R2 have an identical shape. However, as shown in FIG. 9, each of the buttons 50R1 and 50R2 may have a different shape. Specifically, as shown in FIG. 9, each of the buttons 50R1 to 50R6 has a different shape.

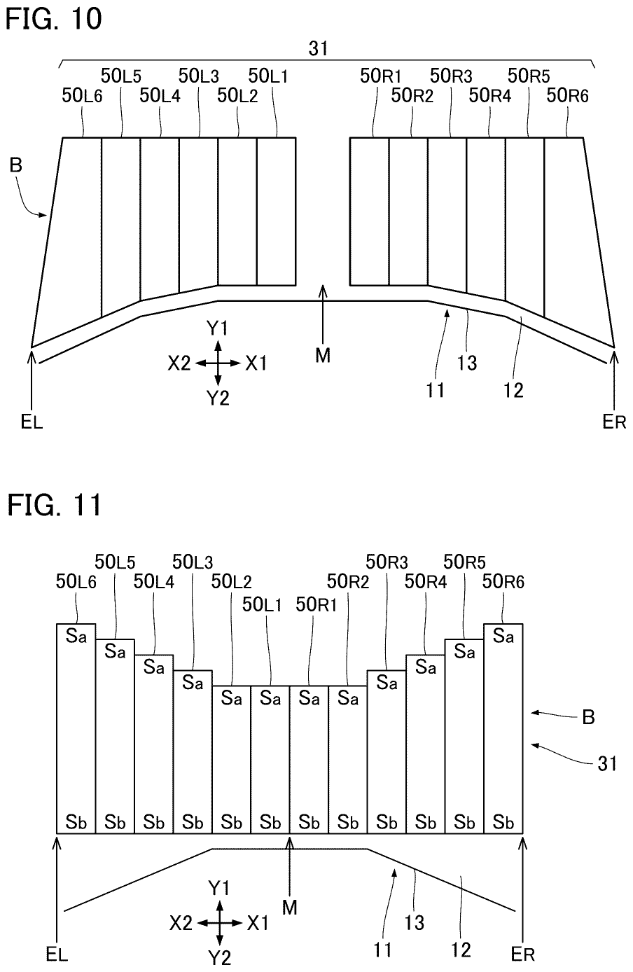

(5) In the foregoing embodiment, the twelve buttons 50 are arranged at equal intervals. However, the arrangement is not limited to this example. For example, as shown in FIG. 10, six buttons 50R1-50R6 and six buttons 50L1-50L6 may be spaced apart and positioned adjacent to each other along the X-axis.

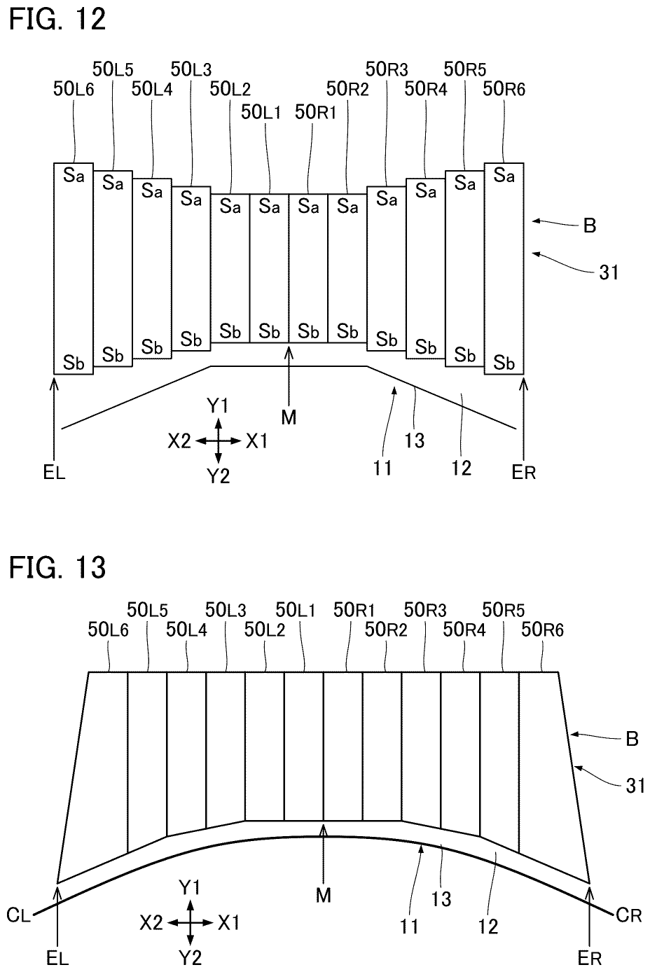

(6) In the foregoing embodiment, across the twelve buttons 50, the position of the edge Sa along the Y-axis is identical. However, as shown in FIGS. 11 and 12, across the button 50, the position of the edge Sa along the Y-axis is different.

As shown in FIG. 11, across the buttons 50, the position of the edge Sa along the Y-axis is different, but the position of the edge Sb along the Y-axis is identical. As shown in FIG. 12, for each button 50, both the position of the edge Sa and the position of the edge Sb along the Y-axis are different.

As will be clear from FIGS. 7 and 11, an aspect of the edge Sb of each button 50 may be selected independently of the shape of the recess 13 of the housing 10. In other words, extension of the edges Sb of the buttons 50 along the recess 13 is not essential in this disclosure and may be omitted as needed.

(7) In the foregoing embodiment, the inner peripheral surface of the recess 13 is formed of a plurality of planar surfaces. However, the shape of the recess 13 is not limited to this example. As shown in FIG. 13, the inner peripheral surface of the recess 13 may be an arcuate curved surface that continues from the right end CR to the left end CL.

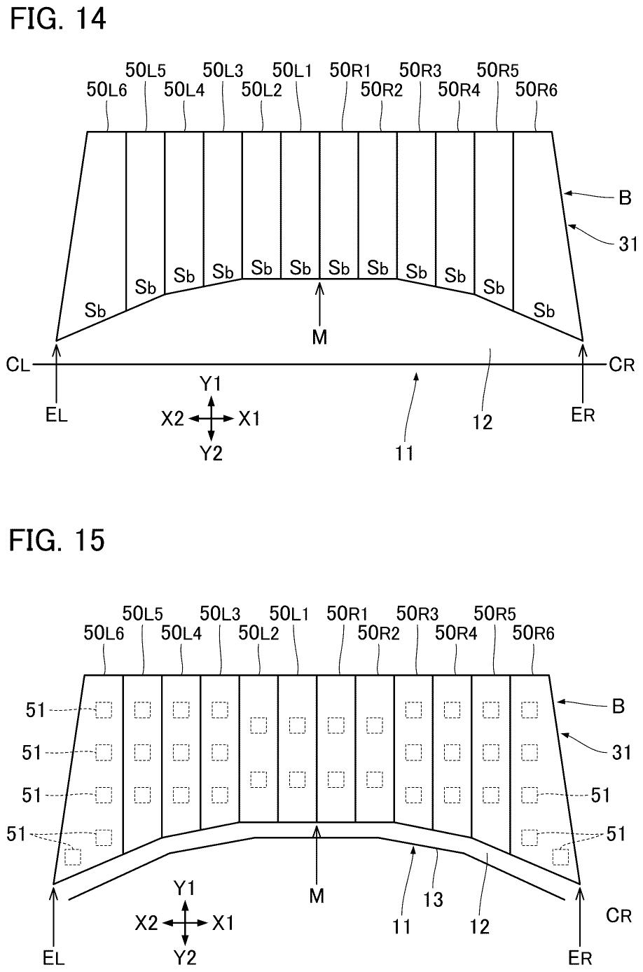

(8) In this embodiment, the recess 13 is disposed in the front surface 11 of the housing 10. However, as shown in FIG. 14, the front surface 11 of the housing 10 may be a flat surface along the X-axis. In other words, the recess 13 may be omitted. As shown in FIG. 14, a distance between the edge Sb of each button 50 and the front surface 11 of the housing 10 differs among the buttons 50. Specifically, a distance between each of the edges Sb of the buttons 50R1 and 50R2 and the front surface 11 is greater than a distance between each of the edges Sb of the buttons 50R3 to 50R6 and the front surface 11.

(9) Each button 50 may be made of a light-transmissive member, such as milky-white resin material. When the buttons 50 are light-transmissive, as shown in FIG. 15, light-emitting elements 51 may be disposed directly beneath respective buttons 50. The light-emitting elements 51 are light sources, such as Light Emitting Diodes, and are controlled by the control device 61. When the user U operates a button 50, the control device 61 causes the corresponding light-emitting element 51 to emit light. The color of light emitted by each light-emitting element 51 may be variable. The light emitted from each light-emitting element 51 passes through the corresponding button 50 and is visible to the user U. This configuration achieves a visual effect.

As shown in FIG. 15, the buttons 50 each have a different number of light-emitting elements 51. Specifically, as the size of the button 50 increases, the number of the light-emitting elements 51 also increases. For example, the buttons 50R1 and 50R2 each may include two light-emitting elements 51, the buttons 50R3 to 50R5 each may include three, and the button 50R6 may include five.

When each button 50 includes the same number of the light-emitting elements 51, the amount of light emitted per unit area differs based on the size of the button 50. As a result, the user U may perceive larger buttons 50 as darker. As shown in FIG. 15, the number of the light-emitting elements 51 varies with the size of each button 50, and a uniform amount of light is perceived by the user U regardless of the size of each button 50. However, the number of light-emitting elements 51 in each button 50 is freely selectable.

(10) In the foregoing embodiment, the buttons 50 of the first set of controls 31 are symmetric, but the first set of controls 31 may be asymmetric. For example, the shapes of the buttons 50 may be identical for either the six buttons 50R1 to 50R6 or the six buttons 50L1 to 50L6. Alternatively, one of the buttons 50R1 to 50R6 and the buttons 50L1 to 50L6 may be omitted.

(11) In the foregoing embodiment, the buttons 50 are displaced in response to operation by the user U. However, in this disclosure, input elements operated by the user U are not limited to the buttons 50. Examples of the input elements include controls, such as knobs that rotate in response to user operation and levers that change their angles or positions in response to user operation.

The “input elements” of this disclosure include controls present in a real space and virtual controls displayed on the display 20. Such virtual controls are operated by touch input from the user U on a touch panel. Alternatively, a touch pad that does not require image display is included in the “input elements.” As will be clear from the examples, in this disclosure, it is not essential for elements forming the input elements to be displaced (e.g., moved or rotated). The virtual controls in a virtual space, operated by the user U (e.g., an avatar), is also included in the “input elements” of this disclosure.

(12) In the foregoing embodiment, the game system 100 to which the input operation apparatus of this disclosure is applied has been exemplified. However, the input operation device operated by the user U may also be configured independently. The input operation apparatus includes a plurality of buttons 50. The input operation apparatus does not depend on the presence of elements, such as a display 20 for displaying the music game screen 21 or functions for controlling the music game (e.g., the control device 61 and the storage device 62).

(13) In the foregoing embodiment, the music game is exemplified. However, the type of the game to which this disclosure is applied is not limited thereto and may be freely chosen. The input operation apparatus of this disclosure may be applied to a device for accepting game input operation from the user U in a variety of games, such as shooting games, action games, role-playing games, adventure games, racing games, puzzle games, simulation games, and table games.

(14) In the foregoing description, the following configurations A and B have been exemplified.

### (Configuration A)

The size of the button 50 positioned farther from the user U is greater than that of the button 50 positioned close to the user U.

### (Configuration B)

The housing 10 has a recess 13 on the front surface 11. Furthermore, in plan view, the edge Sb of each button 50 extends along the recess 13.

The configurations A and B are independent of each other. That is, neither configuration is essential to the other. For example, the configuration B may be adopted in a case in which the plurality of buttons 50 each have a common size: that is, the configuration A is not required.

(15) The notation “n-th” (n is a natural number) in this disclosure is used only as a formal and convenient label to distinguish elements in the notation and carries no substantive meaning. Accordingly, the notation “n-th” should not be construed as limiting the position of each element, the order of manufacture, or similar aspects.

### Appendices

The following preferable aspects of this disclosure are derivable from the foregoing description. To facilitate understanding of the aspects, reference signs used in the drawings are provided in parentheses for convenience. However, it is not intended that this disclosure be limited to the drawings.

### (Appendix 1)

An input operation apparatus (100) according to an aspect (Appendix 1) of this disclosure includes: a plurality of input elements (50) that receive a same type of user operation in a game. The plurality of input elements (50) includes: a first input element (50R6); and a second input element (50R1) positioned closer to a user (U) than the first input element(50R6). The first input element (50R6) has a greater size than the second input element (50R1).

In this aspect, the size of the first input element (50R6) among the plurality of input elements (50) is greater than that of the second input element (50R1), which is positioned closer to the user (U) than the first input element (50R6). As a result, the first input element (50R6) positioned farther from the user (U) can be operated more easily, compared to when all input elements (50), which receive the same type of user operation, are identical in size.

The “same type of user operation” refers to an operation that produces essentially the same effect or function within the game. For example, in a music game that requires user operations at timings synchronized with the playback of a music piece, the operations that the player selectively performs at those synchronized timings are examples of the “same type of user operation.” However, the user operations received by the input elements (50) do not necessarily have to be of the same type at all. For example, even if each of the input elements (50) receives different user operations in a specific mode, the requirement that “the plurality of input elements (50) receive the same type of user operation” is satisfied as long as they receive the same type of user operation in a different mode.

The “size” of the input element (50) refers to the size of an input area. Specifically, when the user (U) operates (e.g., presses) the input element (50) while touching its console panel, the area of the console panel touched by the user (U) constitutes the “size.”

Alternatively, when the input element (50) is pressed vertically downward, the area of its upper surface of the input element 50) corresponds to the “size.”

### (Appendix 2)

In an example (Appendix 2) according to Appendix 1, the plurality of input elements (50) are arranged in a horizontal line. The first input element (50R6) is positioned closer to a first end (ER) of the horizontal line than a position of the user (U) in front of the horizontal line (B) of the plurality of input elements (50). The second input element (50R1) is positioned closer to the position of the user than the first input element (50R6).

In this aspect, the size of the first input element (50R6), which is positioned close to the first end (ER) of the line (B) of the plurality of input elements (50), is greater than the size of the second input element (50R1), which is close to the position in front of the user (U). As a result, compared to when all input elements (50) are identical in size, the first input element (50R6) positioned closer to the first end (ER) can be operated more easily.

### (Appendix 3)

In an example (Appendix 3) according to the Appendix 1, the plurality of input elements (50) are arranged in a line along a first axis (X-axis). The first input element (50R6) is positioned closer to a first end (ER) of the line (B) than a midpoint (M) of the line (B) of the plurality of input elements (50). The second input element (50R1) is positioned closer to the midpoint (M) than the first end (ER).

In this aspect, the size of the first input element (50R6), which is positioned close to the first end (ER) in the line (B) of the plurality of input elements (50), is greater than the size of the second input element (50R1), which is positioned close to the midpoint (M) of the line (B). As a result, compared to when all input elements (50) are identical in size, the first input element (50R6) positioned closer to the first end (ER) can be operated more easily.

The “first axis (X-axis)” may be any axis and includes not only a straight line but also a curved line. The “along the first axis (X-axis)” indicates that the plurality of input elements (50) are arranged so as not to be excessively spaced from the first axis (X-axis). Accordingly, the first axis (X-axis) may be a straight line. In such a case, one possible aspect is that the plurality of input elements (50) are arranged in a straight line in a direction strictly parallel to the first axis (X-axis). Another possible aspect is that a distances between the first axis (X-axis) and the respective input elements (50) differ from one another. As long as the plurality of input elements (50) as a whole are not excessively spaced from the first axis (X-axis), such an aspect is also interpreted as the plurality of input elements (50) being arranged along the first axis (X-axis).

The phrase “first input element (50R6) is close to the first end (ER) than the midpoint (M)” indicates that the distance between the first input element (50R6) and the first end (ER) is less than the distance between the first input element (50R6) and the midpoint (M). Similarly, the phrase “the second input element (50R1) is positioned closer to the midpoint (M) than the first end (ER)” indicates that the distance between the second input element (50R1) and the midpoint (M) is less than the distance between the second input element (50R1) and the first end (ER). Thus, the first input element (50R6) is positioned closer to the first end (ER) as compared to the second input element (50R1). Similarly, the second input element (50R1) is positioned closer to the midpoint (M) as compared to the first input element (50R6).

### (Appendix 4)

In an example (Appendix 4) according to Appendix 3, the plurality of input elements (50) further includes a third input element (50L6) closer to a second end (EL) of the line (B), which second end is opposite to the first end (ER), than to the midpoint of the line (B), and the third input element (50L6) has a greater size than the second input element (50R1).

In this aspect, in addition to the size of the first input element (50R6), which is positioned closer to the first end (ER), the size of the third input element (50L6), which is positioned closer to the opposing second end (EL), is also greater than the size of the second input element (50R1) closer to the midpoint (M) of the line (B). As a result, as compared to when all input elements (50) are identical in size, the input elements (50) (i.e., the first input element (50R6) and the third input element (50L6)) closer to both ends of the line (B) can be operated more easily.

### (Appendix 5)

In an example (Appendix 5) according to Appendix 3 or 4, the plurality of input elements (50) are symmetric with an axis orthogonal to the first axis (X-axis) at the midpoint (M) of the line (B).

In this aspect, the plurality of input elements (50) are symmetric. As a result, the input operation apparatus (100) can achieve a perceived unified design appearance, as compared to when the plurality of input elements (50) are asymmetric.

### (Appendix 6)

In an example (Appendix 6) according to any one of Appendices 3 to 5, each of the plurality of input elements includes: a first edge (Sa) positioned in a first direction (Y1), in which the first direction is along a second axis (Y-axis) orthogonal to the first axis (X-axis); and a second edge (Sb) positioned in a second direction (Y2) opposite the first direction (Y1). The second edge (Sb) of the first input element (50R6) has a greater length than the first edge (Sa) thereof.

In this aspect, the length of the second edge (Sb) of the first input element (50R6) is greater than that of the first edge (Sa) thereof. As a result, it is easy for the user (U) to operate a portion of the first input element (50R6) in the vicinity of the second edge (Sb).

### (Appendix 7)

In an example (Appendix 7) according to Appendix 6, the first edge (Sa) is at an identical position along the second axis (Y-axis) across the plurality of input elements (50).

In this aspect, the position of the first edge (Sa) along the second axis (Y-axis) are identical across the plurality of input elements (50). As a result, as compared to when the position of the first edge (Sa) along the second axis (Y-axis) differs for each input element (50), a unified design appearance can be easily achieved, and the installation structure for the input elements 50 can be simplified.

### (Appendix 8)

In an example (Appendix 8) according to Appendix 7, the second edge (Sb) of the first input element (50R6) is inclined relative to the first axis (X-axis) such that a distance (Lb1) from the first edge (Sa) to an end of the second edge (Sb) close to the first end (ER) of the line is greater than a distance (Lb2) from the first edge (Sa) to an end of the second edge (Sb) close to the midpoint (M) of the line.

In this aspect, the second edge (Sb) of the first input element (50R6) is inclined relative to the first axis (X-axis) such that the end of the second edge (Sb) close to the first end (ER) extends in the second direction (Y2) than the other end of the second edge. This incline allows the user (U) to easily operate the portion in vicinity of the second edge (Sb) of the first input element (50R6), particularly the portion close to the first end (ER).

### (Appendix 9)

In an example (Appendix 9) according to Appendix 8, the plurality of input elements (50) further include a fourth input element (50) positioned between the first input element (50R6) and the second input element (50R1). The second edge (Sb) of the fourth input element (50) is inclined relative to the first axis (X-axis) such that a distance (Lb1) from the first edge (Sa) of the fourth input element (50) to an end of the second edge (Sb) close to the first end (ER) of the line is greater than a distance (Lb2) from the first edge (Sa) of the fourth input element (50) to an end of the second edge (Sb) close to the midpoint (M) of the line. An angle (θb) between the second edge (Sb) of the first input element (50R6) and the first axis (X-axis) is greater than an angle (θa) between the second edge (Sb) of the fourth input element (50) and the first axis (X-axis).

In this aspect, the angle (θb) of the second edge (Sb) of the first input element (50R6) is greater than the angle (θa) of the second edge (Sb) of the fourth input element. This difference in angles produces a consistent design appearance in which the angle of the second edge (Sb) varies progressively from the first input element (50R6) and the fourth input element (50). Furthermore, as compared to when the angle (θb) of the second edge (Sb) of the first input element (50R6) is less than the angle (θa) of the second edge (Sb) of the fourth input element (50), the plurality of input elements (50) are easily installed so as to surround the front and side of the user (U). As a result, the operation of the input elements 50 by the user U can be further facilitated.

### (Appendix 10)

In an example (Appendix 10) according to any one of Appendices 6 to 9, the first input element (50R6) includes: a third edge (Sc) between the first edge (Sa) and the second edge (Sb); and a fourth edge (Sd) between the first edge (Sa) and the second edge (Sb). The fourth edge (Sd) is positioned between the third edge (Sc) and the first end (ER). The fourth edge (Sd) is inclined relative to the second axis (Y-axis) such that a distance (Ld1) from the midpoint (M) of the line to an end of the fourth edge (Sd) close to the second edge (Sb) is greater than a distance (Ld2) from the midpoint (M) to an end of the fourth edge (Sd) close to the first edge (Sa).

In this aspect, the fourth edge (Sd) of the first input element (50R6) is inclined relative to the second axis (Y axis). This inclination allows the user (U) to operate the first input element (50R6) with ease, as compared to when the fourth edge (Sd) is parallel to the second axis (Y-axis).

### (Appendix 11)

In an example (Appendix 11) according to Appendix 10, the input operation apparatus further includes a display (20). The game is a music game that requires a user operation at a timing synchronized with playback of a music piece. The display displays a screen (21) of the music game, the screen including: a lane area (22) having a boundary edge (24R); and a note (23) that is disposed on the lane area (22) and indicates the timing of the user operation. The boundary edge (24R) is inclined relative to a central axis (A) of the lane area (22) such that a distance (WR1) from the central axis (A) to a lower end of the boundary edge (24R) is greater than a distance (WR2) from the central axis (A) to an upper end of the boundary edge (24R).

In this aspect, the fourth edge (Sd) of the first input element (50R6) is inclined relative to the second axis (Y-axis), and the boundary edge (24R) of the lane area (22) on the music game screen is inclined relative to the central axis (A). As a result, the user (U) can be given an impression that the boundary edge (24R) of the lane area (22) and the fourth edge (Sd) of the first input element (50R6) are seamlessly connected. Furthermore, as a result of the perceived continuity, the user (U) can more easily recognize a correspondence between the lane area (22) and the plurality of input element (50).

### (Appendix 12)

In an example (Appendix 12) according to any one of Appendices 1 to 11, the input operation apparatus further includes a housing (10) on which the plurality of input elements (50) are disposed. The housing (10) includes a front surface (11) that faces the user (U). The front surface (11) has a recess (13) from a viewpoint of the user (U).

In this aspect, the user (U) can operate the input elements (50) from a position closer to the input elements (50), as compared to when the front surface (11) of the housing (10) is flat and parallel to the first axis (X-axis). Thus, the user (U) can more easily operate the input elements (50).

### (Appendix 13)

In an example (Appendix 13) according to Appendix 12, in plan view, each of the plurality of input elements (50) has a front-side edge (Sb) that extends along the recess (13).

In this aspect, as compared to when the front-side edge (Sb) of each of the plurality of input elements (50) is arranged in a straight line along the first axis (X-axis), a unified design appearance between the front surface (11) of the housing (10) and the plurality of input elements (50) can be achieved. Furthermore, when the front-side edge (Sb) of each input element (50) extends along the recess (13), the input element (50) close to the end of the line is located closer to the user (U). As a result, the user (U) can easily operate the input elements (50), as compared to when the edges (Sb) of the input elements (50) are linearly arranged.

### DESCRIPTION OF REFERENCE SIGNS

100... game system, 10... housing, 11... front surface, 12... console panel, 13... recess, 20... display, 21... music game screen, 22... lane area, 23... note, 23a... timing note, 23b... arrow note, 24R, 24L ... boundary edge, 25... target position, 30... controls, 31... a first set of controls, 32... a second set of control, 321... fader, 40... sound emitting device, 50, 50R1 to 50R6, 50L1 to 50L6... button, 51... light-emitting element, 61... control device, 62... storage device.

What is claimed is:

1. An input operation apparatus comprising:
a plurality of input elements that receive a same type of user operation in a game, wherein:
the plurality of input elements includes:
a first input element; and
a second input element positioned closer to a user than the first input element, and
the first input element has a greater size than the second input element.

2. The input operation apparatus according to claim 1, wherein:
the plurality of input elements are arranged in a horizontal line,
the first input element is positioned closer to a first end of the line than a position of the user in front of the line of the plurality of input elements, and
the second input element is positioned closer to the position of the user than the first input element.

3. The input operation apparatus according to claim 1, wherein:
the plurality of input elements are arranged in a line along a first axis,
the first input element is positioned closer to a first end of the line than a midpoint of the line of the plurality of input elements, and
the second input element is positioned closer to the midpoint than the first end.

4. The input operation apparatus according to claim 3, wherein:
the plurality of input elements further includes a third input element closer to a second end of the line, which second end is opposite to the first end, than to the midpoint of the line, and
the third input element has a greater size than the second input element.

5. The input operation apparatus according to claim 3,
wherein the plurality of input elements are symmetric with an axis orthogonal to the first axis at the midpoint of the line.

6. The input operation apparatus according to claim 3, wherein:
each of the plurality of input elements includes:
a first edge positioned in a first direction, wherein the first direction is along a second axis orthogonal to the first axis; and
a second edge positioned in a second direction opposite the first direction, and
the second edge of the first input element has a greater length than the first edge thereof.

7. The input operation apparatus according to claim 6,
wherein the first edge is at an identical position along the second axis across the plurality of input elements.

8. The input operation apparatus according to claim 7,
wherein the second edge of the first input element is inclined relative to the first axis such that a distance from the first edge to an end of the second edge close to the first end of the line is greater than a distance from the first edge to an end of the second edge close to the midpoint of the line.

9. The input operation apparatus according to claim 8, wherein:
the plurality of input elements further include a fourth input element positioned between the first input element and the second input element, and
the second edge of the fourth input element is inclined relative to the first axis such that a distance from the first edge of the fourth input element to an end of the second edge close to the first end of the line is greater than a distance from the first edge of the fourth input element to an end of the second edge close to the midpoint of the line, and
an angle between the second edge of the first input element and the first axis is greater than an angle between the second edge of the fourth input element and the first axis.

10. The input operation apparatus according to claim 6, wherein:
the first input element includes:
a third edge between the first edge and the second edge; and
a fourth edge between the first edge and the second edge,
the fourth edge is positioned between the third edge and the first end, and
the fourth edge is inclined relative to the second axis such that a distance from the midpoint of the line to an end of the fourth edge close to the second edge is greater than a distance from the midpoint to an end of the fourth edge close to the first edge.

11. The input operation apparatus according to claim 10, further comprising a display, wherein:
the game is a music game that requires a user operation at a timing synchronized with playback of a music piece,
the display displays a screen of the music game, the screen including:
a lane area having a boundary edge; and
a note that is disposed on the lane area and indicates the timing of the user operation, and
the boundary edge is inclined relative to a central axis of the lane area such that a distance from the central axis to a lower end of the boundary edge is greater than a distance from the central axis to an upper end of the boundary edge.

12. The input operation apparatus according to claim 1, further comprising: a housing on which the plurality of input elements are disposed, wherein:
the housing includes a front surface that faces the user, and
the front surface has a recess from a viewpoint of the user.

13. The input operation apparatus according to claim 12,
wherein, in plan view, each of the plurality of input elements has a front-side edge that extends along the recess.

14. The input operation apparatus according to claim 4,
wherein the plurality of input elements are symmetric with an axis orthogonal to the first axis at the midpoint of the line.
